(19) United States
(12) Patent Application Publication
(10) Pub. No.: US 2016/0300162 A1
(43) Pub. Date: Oct. 13, 2016

(54) APPARATUS AND METHOD FOR MANAGING ACCESS TO A RESOURCE

(71) Applicant: JEFF MCMANUS LTD., Buckinghamshire (GB)

(72) Inventor: Jeff MCMANUS, Buckinghamshire (GB)

(21) Appl. No.: 15/036,454

(22) PCT Filed: Nov. 12, 2014
(86) PCT No.: PCT/GB2014/053355

§ 371 Date: May 13, 2016

Related U.S. Application Data
(63) Continuation of application No. 14/081,015, filed on Nov. 15, 2013.

(51) Int. Cl. G06Q 10/02; G07B 15/02

(52) U.S. Cl. CPC G06Q 10/02; G07B 15/02; G06Q 2240/00

(57) ABSTRACT

A resource access management system and method for managing user access to a resource having a number of resource slots. Each resource slot can be used by a user. The resource access management system is provided with a primary access configured to allow a user to access the resource, the primary access having a first entry point and a first exit point. A secondary access is also provided that is configured to allow users to access the resource. The resource access management system is configured to determine an apparent wait time based on a number of users entering the primary access and the secondary access, and a predetermined resource time associated with the resource. The resource access management system is further configured to periodically determine an actual wait time of a selected user between entering the first entry point and exiting first exit point, and can then calculate a wait time for the primary access using both the apparent wait time and the actual wait time.

### TECHNICAL FIELD

The present invention relates to an apparatus and a method for managing access to a resource.

### BACKGROUND

There are many situations in which the number of users that wish to access a resource increases at a rate that exceeds the rate at which the users are able to access that resource, such that there is an accumulation of users that are waiting to access that resource. By way of example, queues often form when people wish to attend a show or event, board a bus, coach or train, gain entry to a location of interest, make transactions at a bank, make a journey on an aeroplane, ride an attraction at a theme park, access ski chairlifts. Similarly, people also often have to wait to use equipment in a gym or to get a table in a restaurant. Furthermore, queues often form on roads when an alternative toll road is available. The longer that users have to spend waiting to access a resource, the more dissatisfied they will be with their experience, and the greater the likelihood that they will choose not to visit or attempt to access that resource in the future. Furthermore, it will often be the case that whilst the users queue for a first resource they will be unable to access any other resources, nor will they be able to perform other actions that could otherwise be of benefit to the resource provider. For example, whilst a user is queuing to try on clothing in the changing rooms of a department store, they will have only very limited opportunity to view or peruse other items that they may be interested in purchasing, which can therefore limit the revenue generated for the store.

As a way of offering an improved user experience, and of increasing revenue, some resource providers allow users to pay an additional charge in order to minimise the time they spend queuing to access a resource. For example, a large proportion of theme parks now offer visitors the option of paying an additional fee to make use of a “fast track” or “express” access for one or more attractions, which they suggest minimises the time that their visitors must wait, by allowing them to gain entry to the attraction via a separate entrance reserved for those who have paid the additional fee. In addition, some resource providers allow users to make use of virtual queuing, in which users are allocated a place in a virtual queue that is implemented on a computer. The virtual queuing system can then indicate to the user when they should attempt to access the resource based on an estimate of the time at which it is suggested that they will be approaching the front of the virtual queue. For example, such a virtual queuing system can operate in parallel to a standard physical queue, and will therefore be configured to cause a wait of the same length of time as the physical queue. Towards the end of the wait in the virtual queue, the virtual queuing system will notify a user of the virtual queue that they should attempt to access the resource. Typically, a user will be required to pay a fee in order to make use of virtual queuing.

One problem with these methods for managing user access to a resource is that they still require users to spend at least some time waiting in a physical queue, which on a busy day can be very long. For example, whilst the number of user's using a “fast track” or “express” access should ideally be less than the number using a standard access (i.e. the access for those who have not paid for fast track access), there will almost always be at least a small queue of users using the fast track access. For virtual queuing systems, in order to ensure that the utilisation of a resource is maximised, such a virtual queuing system must be configured to ensure that there is a sufficient number of users present at the resource on each occasion that the resource becomes available. The only way to achieve this is to provide the users with an early indication of the time at which users will be approaching the front of the virtual queue, such that the users have more than enough time to reach the resource before they are actually due to reach the front of the queue. Consequently, resource providers/operators are required to provide a separate queue/waiting area for users of these fast track/virtual queuing systems, as well as a standard access queue/waiting area, which therefore consumes space and incurs a cost to install, operate and maintain. In addition, even if users spend only a small amount of time in a queue, this still impacts on the amount of time that these users can spend generating revenue for the resource provider via other revenue streams. Two or more lines are common in many environments.

Furthermore, as these methods still require at least some time in a queue, it is still possible that users will be dissatisfied with their experience. For example, if a significant number of users decide to make use of a “fast track” or “express” access at approximately the same time, i.e. they bunch/cluster together in large numbers, then the number of users in queuing for the “fast track” or “express” access can potentially grow to the point where the length of the queue is close to, or even exceeds, the length of the queue for the standard access. This will likely discourage users from paying the additional charge for the “fast track” or “express” access, and potentially cause frustration to those users who may have already paid to use the “fast track” or “express” access before they were aware of the relatively high level of demand. By way of further example, as virtual queuing systems rely on an estimate of the time at which users will be approaching the front of the virtual queue, if this estimate is even slightly too short, or the timing of the indication to the user is even slightly too early, then the number of user's in the actual queue can potentially grow to the point where users are unhappy with the length of the time that they are required to wait. Moreover, if the estimate is even slightly too long, or the timing of the indication to the user are even slightly too late, then there will not be enough users present at the resource on each occasion that the resource becomes available to maximise the available capacity. Consequently, such methods for managing user access to a resource do not ensure that use of the available capacity of a resource is maximised/optimised, do not always lead to an improved user experience, and do not optimise the revenue opportunities for the resource provider. Moreover, with conventional resource access management methods, if significant bunching/clustering does take place at a “fast track” or “express” access, then this can only be reduced by allowing the users in the “fast track” or “express” access to access the resource in increased, if not continuous, preference to those users that are queuing to use the standard access, which can cause significant dismay and anger to the users queuing to use the standard access.

A further problem is that of monitoring a wait time for access to the resource. It is desirable to charge for “fast track” access on the time saved by avoiding queuing using a standard access. Currently, wait time is monitored by estimating a number of users accessing the resource and dividing that by the time required to use the resource. For example, if fifty users access a ride that carries ten people for two minutes, then the wait time is estimated to be ten minutes. However, this can be inaccurate and misleading. For example, each instance of the ride may not operate at full capacity, in which case the wait time will be longer than the estimate. Furthermore, wait time is typically estimated by determining the length of the standard access queue when a fast-track queue is also available. Given the variable utilization of the fast-track queue, from a few attendees to perhaps half the number of users attempting to access the resource, the inaccuracy of the wait time can be up to two-fold.

### SUMMARY

It is an object of the present invention to provide a system and method for managing user access to a resource in which at least a portion of the users that wish to access a resource can do so more quickly than other users, and to more accurately determine a wait time for access to the resource. There are described mechanisms for access to a resource and techniques for counting the number of users attempting to access the resource, and charging users for access to the resourse.

According to a first aspect there is provided a resource access management system for managing user access to a resource having a number of resource slots. Each resource slot can be used by a user. The resource access management system is provided with a primary access configured to allow a user to access the resource, the primary access having a first entry point and a first exit point. A secondary access is also provided that is configured to allow users to access the resource. The resource access management system is configured to determine an apparent wait time based on a number of users entering the primary access and the secondary access, and a predetermined resource time associated with the resource. The resource access management system is further configured to periodically determine an actual wait time of a selected user between entering the first entry point and exiting first exit point, and can then calculate a wait time for the primary access using both the apparent wait time and the actual wait time. This provides a much more accurate estimation of wait time for users using the primary access than was previously possible.

The determination of the actual wait time between a user entering and exiting may be made using a wireless signal from a device associated with the user or other unique identifiers. Examples of such devices include a mobile terminal, a radio frequency tag, and a card comprising an identification code

The determination of the actual wait time is made using a visual recognition device located at the first entry point and the first exit point. This may recognise, for example, faces, distinctive clothing or any other visual clue allowing an individual user to be uniquely identified.

The resource access management system may be provided with a computer device for dynamically determining a cost to access the resource via the secondary access on the basis of the calculated wait time for the primary access. It may also take into account factors such as historical wait times, marketing promotions, date, system overheads, speed of access, and weather.

An example of a resource is a seat on a ride. In another example, the resource is a road and the primary access is a route on the route, and the secondary access is an alternative route on the road.

The resource access management system is optionally provided with a further secondary access configured to allow users to access an alternative resource.

The resource access management system is optionally further configured to calculate the wait time on the further basis of known or estimated bookings for resources using the secondary access.

The resource access management system is optionally further configured to manage access to a plurality of resources.

A charging module is optionally provided to determine a charge for secondary access to the resource based on the calculated wait time. The charge for secondary access to the resource is optionally directly proportional to the calculated wait time. The system optionally further comprises means to inform the user of the calculated wait time for the resource, the means selected from any of a display screen in a public area and a transmitter for sending to a user mobile device information including the identity of the resource and the calculated wait time. The charging module is optionally further configured to store data relating to the user, the data including an identity of the user and an account of money and/or early entry waiting time available to the user.

According to a second aspect, there is provided a computer device arranged to calculate a wait time for access to a resource having a number of resource slots, wherein each resource slot can be used by a user. The computer device is provided with a first data input for receiving data relating to a number of users entering a primary access configured to allow a user to access the resource, the primary access having a first entry point and a first exit point. A processor is configured to determine an apparent wait time based on the number of users entering the primary access and a secondary access, and a predetermined resource time associated with the resource. A second data input is provided for receiving data relating to a periodically determined actual wait time of a selected user between entering a first entry point of the primary access and exiting a first exit point of the primary access. The processor is further arranged to calculate a wait time for the primary access using both the apparent wait time and the actual wait time.

Note that there could be further accesses to the resource or positions on the resource.

As an option, the processor is further arranged to dynamically determine a cost to access the resource via a secondary access on the basis of the calculated wait time for the primary access. It may also take into account any of historical wait times, marketing promotions, date, system overheads, speed of access, and weather.

According to a third aspect, there is provided a resource access management system for managing user access to a resource having a number of resource slots, wherein each resource slot can be used by a user. A primary access is configured to allow a user to access the resource, the primary access having a first entry point and a first exit point. A secondary access is configured to allow users to access the resource. A computer device is configured to calculate a wait time to access the resource using the primary access. A charging module is arranged to determine, on the basis of the calculated wait time, a price to access the resource using the secondary access.

As an option, the price to access the resource using the secondary access is directly proportional to the calculated wait time. The system optionally further comprises means to inform a user of the calculated wait time for access to the resource using the primary access, the means selected from any of a display screen in a public area and a transmitter for sending to a user mobile device information including the identity of the resource and the calculated wait time.

The charging module is optionally configured to store data relating to the user, the data including an identity of the user and an account of money and/or early entry waiting time available to the user.

The resource may be, for example, a seat on a ride. Alternatively, the primary access is a route on a road and the secondary access is an alternative route on the road.

According to a fourth aspect, there is provided a method of calculating a wait time for a user to access a resource. A computer determines an apparent wait time based on a number of users entering a first entry point of a primary access and a number of users entering a secondary access, and a predetermined resource time associated with the resource. Periodically, a determination is made of an actual wait time of a selected user between entering the first entry point and exiting a first exit point of the primary access. A wait time for the primary access is calculated using both the apparent wait time and the actual wait time. In other words, estimated wait time can be obtained by refining a rough estimate of a group of users waiting to access the resource using the actual wait time of a small number of members of the group.

As an option, the method further comprises dynamically determining a cost to access the resource via a secondary access on the basis of the calculated wait time for the primary access, and optionally may also use any of historical wait times, marketing promotions, date, system overheads, speed of access, and weather.

The wait time is optionally calculated on the further basis of known or estimated bookings for resources using the secondary access.

### BRIEF DESCRIPTION OF THE DRAWINGS

Some embodiments of the present invention will now be described in detail with reference to the accompanying drawings, in which:

FIG. 1 illustrates schematically an exemplary resource access management system suitable for managing user access to a resource;

FIG. 2 is a flow diagram illustrating an exemplary process for managing user access to a resource;

FIG. 3 is a flow diagram illustrating an exemplary process for measuring a wait time for accessing the resource;

FIG. 4 illustrates schematically in a block diagram an exemplary computer device; and

FIG. 5 is a flow diagram showing an exemplary charging method.

### DETAILED DESCRIPTION

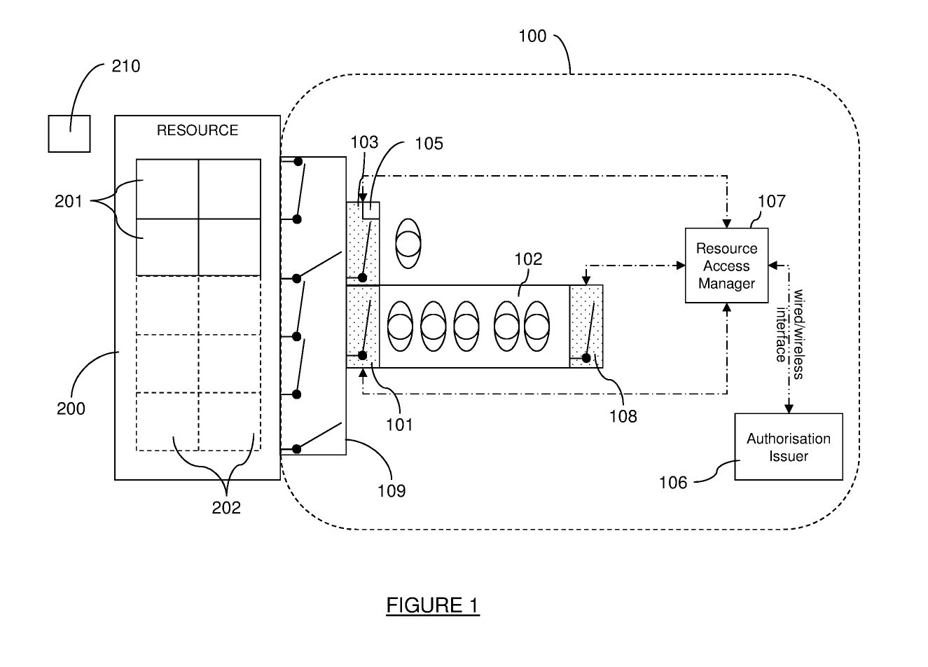

In order to at least mitigate the problems outlined above, it is proposed here to provide a resource access management system that ensures that at least a proportion of the user's that wish to access a resource can do so without having to spend time in a queue. FIG. 1 illustrates schematically an example of such a resource access management system 100 suitable for managing user access to a resource 200. The system 100 comprises a primary access 101 (e.g. that can be used without acceptance of an associated charge, and can be thought of as a “standard access”) and a primary access queue enclosure 102 through which users must pass to reach/access the resource 200 via the primary access 101. The primary access queue enclosure 102 therefore provides an area in which users wishing to access the resource 200 via the primary access 101 can queue/wait. The system 100 further comprises a secondary access 103 (which may be thought of as a “fast-track access”) through which users can access the resource 200 provided they have a valid authorisation to do so. Both the primary access 101 and the secondary access 103 are controlled. For example, one or both of the primary access 101 and the secondary access 103 can comprise a turnstile or gate arrangement that can transition between a locked and an unlocked state so as to only allow users to access the resource 200 in appropriate circumstances and/or when a user has met some criteria for access.

Note that the description refers to a secondary access 103, but it will be appreciated that there may be more than one secondary access. In some circumstances, different secondary accesses can provide access to different resources. For example, where the resources are seats on a roller coaster, some may face forward and some may face backwards. In this case, a secondary fast track access may be provided for forward-facing seats, and a further secondary fast-track access may be provided for rear-facing seats.

Note also that while the description below refers to a ‘gate’, this need not be a physical gate but is a barrier through which a user must pass to access a resource. This could be a physical gate, a turnstyle, or simply a human operator admitting or denying access.

The resource 200 has a number of resource slots/positions/spaces/seats/groups of seats available that can be used by users for each occurrence of the resource. The system 100 is configured such that a portion of these resource slots are at least initially available to be allocated for use by users that access the resource using the secondary access 103, and are therefore referred to as allocable or reservable resource slots 201 (indicated by solid boxes in FIG. 1). The remaining resource slots are at least initially available for use by the users that access the resource using the primary access 101, and are therefore referred to as non-allocable or non-reservable resource slots 202 (indicated by dashed boxes in FIG. 1). Therefore, for each occurrence of the resource 200, the secondary access 103 enables users that have a valid authorisation to access the resource 200 (i.e. without having to queue), wherein the number of users that have a valid authorisation will not exceed the number of allocable resource slots 201. This control may be by way of an automatic gate with the user having an authorising token that opens the gate, or by way of a person who is able to validate the authority of the user. The primary access 101 enables users in the primary access queue enclosure 102 to access the resource 200 on a first come, first served (FCFS) basis, wherein the number of users that will be allowed to access an occurrence of the resource 200 using the primary access 101 will be at least equal to the number of non-allocable resource slots 202. The system 100 could be configured to allow user's accessing the resource 200 using the primary access 101 to make use of any unallocated/unreserved allocable resource slots 201 (i.e. any allocable resource slots 201 that are not allocated to users of the secondary access 103) as well as the non-allocable resource slots 202. This would ensure that utilisation of the resource 200 is maximised for each occurrence of the resource 200.

Optionally, the system 100 can be configured such that primary access 101 and the secondary access 103 are controllable so as to allow users to access the resource in a particular order. For example, the system 100 could be configured such that, when the resource 200 becomes available for a particular occurrence, the secondary access 103 allows user's that have a valid authorisation to access the resource, prior to allowing the user's in the primary access queue enclosure 102 to access the resource on first come, first served basis. This would be particularly useful in order to allow the users of the secondary access 103 to access a specifically allocated resource slot, or in order to provide users of the secondary access 103 with the opportunity to preferentially select the resource slot of their choice.

In order to determine if a user has a valid authorisation to access the resource 200 using the secondary access 103, the secondary access 103 can be provided with an authorisation verifier 105. The authorisation verifier 105 would be configured to validate the user's right to access a particular occurrence of the resource 200 using the secondary access 103, and to control the secondary access 103 accordingly. To do so, the authorisation verifier 105 would be configured with an interface that enables it to accept or collect authorisation information from a user, and to process this authorisation information in order to determine if it is associated with a valid authorisation to access a particular occurrence of the resource 200. As described earlier, this may be by way of an automatic verification system or a human operative who can authorise the user.

The system 100 will therefore also typically comprise an authorisation issuer 106 configured to provide user's with an authorisation to access a particular occurrence of the resource 200 using the secondary access 103. In this regard, a user will normally only be provided with an authorisation to access a particular occurrence of the resource 200 using the secondary access 103 upon acceptance of an associated charge. For example, the authorisation issuer 106 could comprise a computer device having a user interface through which users can interact with the authorisation issuer 106. The authorisation issuer 106 would thereby indicate to users a charge associated with accessing one or several alternative occurrences of the resource 200 using the secondary access 103, allow users to select a particular occurrence of the resource 200 and to accept the associated charge. The authorisation issuer 106 would then be configured to provide the user within some authorisation information that can be used by the authorisation verifier 105 to confirm that the user has a valid authorisation, or to associate some user identification data with authorisation information (i.e. relating to the particular occurrence of the resource 200 for which the user has been authorised to use the secondary access 103) and to enable the authorisation verifier 105 to access this authorisation information. The authorisation issuer 106 could be configured to allow users to accept an associated charge using any of a number of forms of payment, such as cash, credit or debit cards, tokens, vouchers, contactless payment, transfers etc.

According to a first example, the authorisation issuer 106 could be configured to issue an access token, in the form of a physical or electronic ticket or voucher, to a user that has obtained an authorisation to use the secondary access 103 to access a particular occurrence of the resource 200 (e.g. who has accepted a charge associated with using the secondary access 103). Authorisation information relating to the particular occurrence of the resource 200 for which the user has been authorised to use the secondary access 103 would be encoded onto or associated with the token. The user would then present this token to the authorisation verifier 105. The authorisation verifier 105 would be configured to scan/read the token (e.g. using a barcode, a bokode, a QR code, programmable RFID, Bluetooth, near field communication (NFC) etc) to determine the user's authorisation information, and would only allow the user to use the secondary access 103 at the time of the particular occurrence of the resource 200 that the user has been authorised to access the resource (i.e. in accordance with the authorisation information determined from the analysis/interrogation of the access token). Typically, the authorisation issuer 106 would be configured to issue an access token that the authorisation verifier 105 would only determine to be valid for a single user and a single occurrence of the resource. However, if desired, the authorisation verifier 105 could be configured to retain, destroy or otherwise modify the access token so as to prevent its valid use to access any further occurrence of the resource for which the user has not obtained an authorisation. For example, if the access token was provided electronically, then the authorisation verifier 105 could be configured to the valid authorisation information associated with this access token from the system memory so as to preclude a second use of this access token for this resource.

According to a second example, the authorisation issuer 106 could be configured to issue an access token, in the form of an access code, to a user that has obtained an authorisation to use the secondary access 103 to access a particular occurrence of the resource 200. This access code could be manually recorded by the user, or could comprise electronic information transmitted to a portable computer device or other recognisable article carried or worn by or part of the user. Authorisation information relating to the particular occurrence of the resource 200 for which the user has been authorised to use the secondary access 103 would be encoded within or associated with the access code. The user would then provide this access code to the authorisation verifier 105 (e.g. by manually inputting or electronically transmitting the access code etc). The authorisation verifier 105 would be configured to determine the authorisation information using the access code, and would only allow the user to use the secondary access 103 at the time of the particular occurrence of the resource 200 that the user has been authorised to access the resource (i.e. in accordance with the authorisation information determined from the access code). Typically, the authorisation issuer 106 would be configured to issue an access code that the authorisation verifier 105 would only determine to be valid for a single user and a single occurrence of the resource.

According to a third example, the authorisation issuer 106 could be configured to obtain biometric data from a user that has obtained an authorisation to use the secondary access 103 to access a particular occurrence of the resource 200. This biometric data can then be stored in association with authorisation information relating to the particular occurrence of the resource 200 for which the user has been authorised to use the secondary access 103. The user would then present themselves to the authorisation verifier 105, and the authorisation verifier 105 would be configured to obtain corresponding biometric data from the user. The authorisation verifier 105 would be configured to use the obtained biometric data to determine the user's authorisation information, and would only allow the user to use the secondary access 103 at the time of the particular occurrence of the resource 200 that the user has been authorised to access the resource (i.e. in accordance with the authorisation information determined from the biometric data). Typically, the authorisation issuer 106 would be configured to associate authorisation information with biometric data that the authorisation verifier 105 would only determine to be valid for a single user and a single occurrence of the resource.

The system 100 can optionally comprise a resource access manager 107 that is communicatively connected to one or both of the primary access 101 and the secondary access 103. The connections between the resource access manager 107 and one or both of the primary access 101 and the secondary access 103 allows the resource access manager 107 to obtain information from each access, and to send information and/or instructions to each access.

For example, this would enable one or both of the primary access 101 and the secondary access 103 to communicate with the resource access manager 107 such that the resource access manager 107 is aware of the number of users that access the resource 200 using each access. For example, one or both of the primary access 101 and the secondary access 103 can communicate with the resource access manager 107 each time the access is used by a user to access the resource 200 such that the resource access manager 107 can provide a register. Alternatively, one or both of the primary access 101 and the secondary access 103 can be provided with or connected to a register (not shown) or other means for determining when a user passes through the access to count and/or record the number of user's that have passed through the access. Preferably, one or both of the primary access 101 and the secondary access 103 would be able to identify each individual that makes use of the primary access 101 and the secondary access 103 respectively. One or both of the primary access 101 and the secondary access 103 could then send occasional reports to the resource access manager 107, each report providing information regarding the user's that have accessed the resource 200 since the last report sent by that access. Through communication with both the primary access 101 and the secondary access 103, the resource access manager 107 can be configured to monitor the usage levels of each access. This information can then be used by a system administrator to adjust the system configuration if so desired.

The resource access manager 107 could also be communicatively connected to one or both of the authorisation verifier 105 and the authorisation issuer 106 via either of a wired interface or a wireless interface (illustrated by the dot-dash lines in FIG. 1). Through communication with the primary access 101, the secondary access 103 and the authorisation issuer 106, the resource access manager 107 could be configured to control the issue of authorisations by the authorisation issuer 106, and to thereby control access to the resource using the secondary access 103. For example, the resource access manager 107 could be configured to control the primary access 101 and the secondary access 103 so as to allow users to access the resource in a particular order (as described above), by only allowing access to the resource 200 using the primary access 101 when the authorisation verifier 105 has informed the resource access manager 107 that all of authorisations issued for a particular occurrence of the resource 200 have been used to access the resource 200 using the secondary access 103. By way of further example, the resource access manager 107 could be configured to monitor the level of demand for access to the resource 200 using one or both of the primary access 101 and the secondary access 103, and to automatically adjust the associated charge (i.e. levied by the authorisation issuer 106) for using the secondary access 103 in dependence upon the monitored level of demand for access to the resource 200.

In addition, in order to minimise the possibility that a queue will form at the secondary access 103, the resource access manager 107 could be configured to measure and/or estimate the frequency of occurrence of the resource 200, and use the measured and/or estimated frequency of occurrence of the resource 200 to determine the frequency with which authorisations to use the secondary access 103 should be issued. For example, the resource 200 could be configured to measure the times at which/period with which it becomes available (i.e. by using of one or more sensors (not shown)), and to report this directly or indirectly to the resource access manager 107. The resource access manager 107 can then use the periods/times measured by the resource 200 to determine the frequency with which authorisations to use the secondary access 103 should be issued by the authorisation issuer 106. By way of example, the resource access manager 107 could be configured to determine/estimate that the frequency of occurrence of resource 200 is equal to the most recently measured period/times, or an average of a number of measured period/times etc, and thereby determine/estimate the time at which future occurrences of the resource 200 will take place. The resource access manager 107 would then instruct the authorisation issuer 106 to only issue authorisations that allow use of the secondary access 103 at the predicted times of occurrence of the resource 200.

The skilled person will realise that other methods of counting the number of users accessing the resource. For example, a counter 210 could be provided at the exit of the resource.

Moreover, if it is desired that the resource access manager 107 monitor the level of demand for access to the resource 200, then the system can further comprise a primary access queue entrance 108, through which users must pass in order to enter the primary access queue enclosure 102 and thereby join the queue for the primary access 101. This primary access queue entrance 108 can also be provided with or connected to a register (not shown) or other means for determining when a user passes through the entrance to count and/or record the number of users that have passed through the entrance. For example, the primary access queue entrance 108 can be provided by a turnstile or gate arrangement that is communicatively connected to the resource access manager 107, or people can be counted using a counting device such as a camera and software configured to identify an individual. Preferably, the primary access queue entrance 108 will also be able to identify each individual that enters the primary access queue enclosure 102 through primary access queue entrance 108. The resource access manager 107 can therefore communicate with the primary access queue entrance 108 to obtain information regarding the users that have joined the queue. The resource access manager 107 can then use this information, in combination with the information received from the primary access 101, to determine the number of users currently in the queue, and thereby determine the level of demand for the access to the resource 200. For example, a measure of the level of demand could be determined as the estimated time it will take a user who joins the queue to obtain access to the resource 200 (e.g. the time a user joining the back of the queue will have to wait). This could be based on one or both of the rate of arrival of users through the primary access queue entrance 108 and the number of users who have been issued with authorisations to contemporarily access the resource 200 through secondary access 103.

As outlined above, it is preferable that the primary access queue entrance 108 will be configured to identify an individual that enters the primary access queue enclosure 102. Similarly, the primary access 101 would then be configured to identify an individual that exits the primary access queue enclosure 102. For example, the primary access queue entrance 108 and the primary access 101 can identify a user that passes through by scanning/reading an access token carried by the user (e.g. using a barcode, a bokode, a QR code, programmable RFID, Bluetooth, near field communication (NFC) etc), using biometric scanning, etc. The primary access queue entrance 108 and the primary access 101 can then be configured to report this information to the resource access manager 107.

By identifying an individual user as they enter and exit the primary access queue enclosure 102, and notifying the resource access manager 107 accordingly, this enables the resource access manager to accurately determine number of users that are queuing/waiting in the primary access queue enclosure 102 and to determine the length of time that each user spends in the primary access queue enclosure 102. This information can then be used to accurately estimate the current waiting time for a user who was to presently enter the primary access queue enclosure 102. This estimate will have significantly better accuracy than waiting times estimates provided be conventional resource access systems, which typically rely on a visual assessment of the physical length of the queue by the operator or a simple timing system. The estimated waiting time can then be displayed to users, and can also be used when determining the charge associated with using the secondary access 103.

The resource access management system 100 described above therefore also makes it possible for the charge that the user is required to accept to be determined in proportion to the predicted or calculated reduction in the time that the user is required to wait, such that the lower the reduction in the waiting time that is provided by the option of using the secondary access 103 for a particular occurrence of the resource 200, the lower the charge to the user. By way of further example, this also makes it possible for the charge that the user is required to accept to be determined in proportion to the number of or rate at which users are making use of the resource access management system 100 to obtain access to an allocable resource slot 201 for a particular occurrence of the resource 200. In addition, this also makes it possible for the charge that the user is required to accept to be determined based on the specific particular occurrence of the resource 200 which the user chooses. For example, if a user wishes to access an occurrence of the resource 200 at a time in the very near/immediate future, then the charge for reserving access for this occurrence can be determined to be higher than if the user is prepared to wait until later to access the resource. Additionally, the calculation of the charge that is required to be accepted can also take into account factors that are based on historical booking data (e.g. so as to take account of the impact of the time of day, the day of the week, public holidays etc) and contemporary parameters (e.g. such as the current weather etc. This information could be input to system manually, or collected automatically by the system.

Of course, the charge can be determined based on any one of, or a combination of any of these factors. This system 100 therefore also provides for increased flexibility in the charging mechanisms available to the resource provider, which in turn can increase the likelihood that users wishing to access the resource will accept the charge for using the secondary access 103 to access a particular occurrence of the resource 200, even when the levels of demand for the resource are relatively low, as the charge for doing so will also be relatively low. This system 100 for managing user access to a resource therefore leads to a further improved user experience, and further optimises the revenue opportunities for the resource provider.

The resource access management system 100 may also comprise a single resource access manager 107 managing access to multiple resources, wherein each resource will be provided with a primary access 101 and a secondary access 103. The resource access management system 100 can then be configured to provide that the charge for accessing an occurrence of a first resource is different to that for accessing an occurrence of a second resource. For example, the system could be configured to provide that the charge for using a secondary access to access the most popular and/or expensive to run resources is greater than the charge for using a secondary access to access those resources that are less popular and/or less expensive to run. This also provides the resource access management system 100 with another means for managing access to a resource. For example, this provides that the resource access management system 100 can determine that the charge for accessing an occurrence of a resource that is preferable to the resource provider will be lower than that for accessing an occurrence of the resource that is not preferable to the resource provider, e.g. during the lunch hour, so as to encourage users to access the resource at the time preferred by the resource provider. Of course, the charge can be determined based on any one of, or a combination of any of the factors outlined above.

The resource access management system 100 may optionally comprise a resource slot allocation system 109. This resource slot allocation system 109 would be located between the primary access 101 and the secondary access 103 and would be configured to control which resource slots of the resource 200 can be accessed by the users of both the primary access 101 and the secondary access 103. For example, the resource slot allocation system 109 could be configured to only allow access to one or more preferred resource slot(s) of the resource 200 to those users of the secondary access 103 that are authorised to use those preferred slot(s). The resource slot allocation system 109 would therefore prevent any unauthorised users from accessing those preferred slots, and would only allow unauthorised users to access the remaining slots. By way of further example, as illustrated in FIG. 1, the resource access management system 100 could be provided by a gating arrangement that cooperates with and/or is controlled by the resource access management system 100 and/or the authorisation verifier 105 so as to regulate which of the resource slots can be accessed by the users. However, the resource slot allocation system 109 could be provided by any suitable gating arrangement or configurable structure and is not limited to the illustrated embodiment.

In addition, depending upon the type of resource(s) for which the resource access management system 100 is used, the resource access management system 100 could be configured with more than one secondary access through which the resource can be accessed. For example, each secondary access that can be used to access a resource can relate to a different segment or subset of the allocable resource slots (e.g. for seats at the front or back of a rollercoaster ride, or different areas of a theatre, cinema or other viewing attraction). The authorisation issuer 106 would then be configured to issue authorisations for a particular occurrence of a resource that only allows access to the resource through an associated secondary access. For example, the charge associated with using a first secondary access to access a first subset of the allocable resource slots for an occurrence of a resource could then be configured to be greater than the charge associated with using a second secondary access to access a second subset of the allocable resource slots for the same occurrence of the resource. For example, the authorisation issuer 106 and the authorisation verifier 105 of each secondary access could be configured such that the authorisation verifier 105 could identify a specific allocable resource slot that has been allocated to the user, and to allow the user to use the secondary access via which the user can access the identified allocable resource slot.

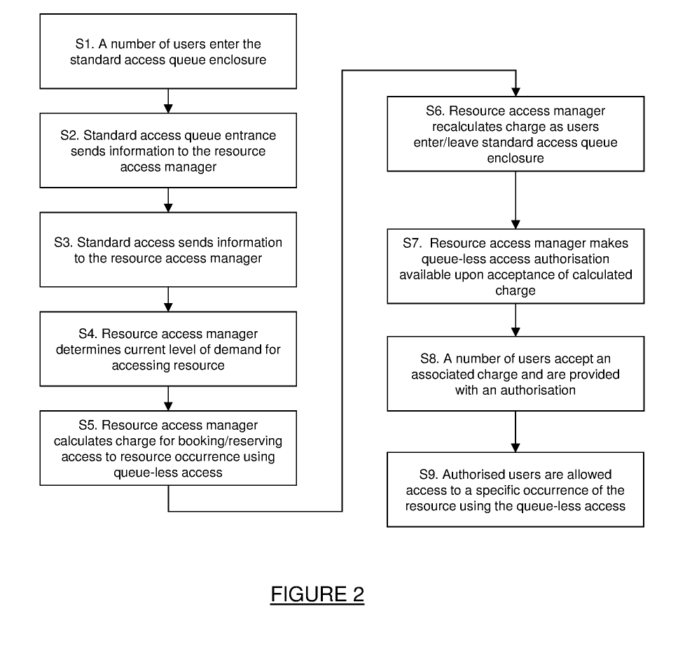

FIG. 2 is a flow diagram illustrating an example of the process for managing user access to a resource as outlined above. The steps performed are as follows:

S1. A number of users wishing to access the resource using the primary access 101 attempt to do so by entering through the primary access queue entrance 108, and form a queue of uses waiting in the primary access queue enclosure 102.

S2. The primary access queue entrance 108 sends information to the resource access manager 107 that allows the resource access manager 107 to determine the number of users that have entered the primary access queue enclosure 102. For example, this may involve reporting to the resource access manager 107 each time a user passes through the primary access queue entrance 108, or may involve sending regular/periodic reports to the resource access manager 107, each report identifying the users that have entered the primary access queue enclosure 102 since the last report, and the time at which they entered.

S3. Similarly, the primary access 101 sends information to the resource access manager 107 that allows the resource access manager 107 to determine the number of users that have left/exited the primary access queue enclosure 102. For example, this may involve reporting to the resource access manager 107 each time a user passes through the primary access 101, or may involve sending regular/periodic reports to the resource access manager 107, each report identifying the users that have exited the primary access queue enclosure 102 since the last report, and the time at which they left.

S4. The resource access manager 107 can then determine the number of users in the primary access queue enclosure 102, and the length of time each user spends waiting in the primary access queue enclosure 102, based on the information provided by the primary access entrance 108 and primary access 101, and thus will be able to accurately estimate the current waiting time for a user who was to presently enter the primary access queue enclosure 102. The resource access manager 107 then uses this estimate of the primary access waiting time to establish the current the level of demand for the resource 200.

S5. Based on the level of demand or the wait time for the resource 200, the resource access manager 107 calculates a charge that must be accepted by a user that wishes to make use of the resource access management system to book/reserve access to the resource at a specific time via the secondary access 103. For example, this charge can be proportional to the reduction in the time that the user would have been required to wait to access the resource 200 if they had made use of the primary access 101 rather than the secondary access 103. In addition, or alternatively, this charge can be proportional to the rate at which users are making use of the booking/reservation system to access a specific occurrence of the resource 200 via the secondary access 103. Of course, the charge can be determined based on any one of, or a combination of any of the factors described herein, such as a system overhead or a specific charge for the resource. For example, a charge may be levied for queue time saved (e.g. a charge per minute) in addition to a fixed charge associate with the resource.

S6. As the number of users in the primary access queue enclosure 102 changes (e.g. due to the change in the rate of users joining and/or leaving the primary access queue enclosure 102), such that the waiting time in the primary access queue enclosure 102 changes, the resource access manager 107 can modify the established current level of demand, and can modify/recalculate the charge for accessing the resource 200 using the secondary access 103 accordingly.

S7. The resource access manager 107 then offers users the opportunity to book/reserve access to a specific occurrence of the resource 200 using the secondary access 103 upon acceptance of the calculated charge. For example, the resource access manager 107 can be connected to one or more authorisation issuers 106 that are distributed around the location in which the resource 200 can be found, and each of the one or more authorisation issuers 106 enable users to view and accept the required charge, and can provide authorisations accordingly, wherein the number of authorisations available for an occurrence of the resource 200 will not exceed the number of allocable resource slots that are available.

S8. A number of users wishing to make use of the secondary access 103 to access a specific occurrence of the resource 200 accept an associated charge and are provided with an authorisation that is valid for that occurrence of the resource 200. If required, information regarding the authorisation can be communicated from the authorisation issuer 106 that issued the authorisation to the authorisation verifier 105 at the secondary access 103 (either directly or via the resource access manager 107). Alternatively, the system can be configured such that an authorisation issuer 106 can issue authorisations that will be recognised by an authorisation verifier 105 without the need for explicit communication between them. For example, this could be achieved by pre-configuring an authorisation issuer 106 and an authorisation verifier 105 with shared authorisation information from which any issued authorisations are derived and verified.

S9. A user that has a valid authorisation to access a particular occurrence of the resource 200 via the secondary access 103 can then approach the secondary access 103 at the time of the occurrence of the resource, and present/provide the associated authorisation verifier 105 with information identifying their authorisation, in accordance with any of the methods described herein. The authorisation verifier 105 will therefore verify a valid authorisation and allow the user to access the resource 200 using the secondary access 103.

It is desirable to be able to set prices for the secondary access 103 according to the amount of time saved compared to queuing for the primary access 101. As described above, currently wait times are based on a combination of the number of users entering attempting to use the resource, a time associated with the resource (such as the length of a roller-coaster ride), and the capacity of the resource (such as the number of seats on the roller-coaster). However, this estimated wait time can be inaccurate, especially if the resource is not always used at full capacity.

In order to make the estimated wait time more accurate, it is proposed to periodically determine the time between an individual user entering the primary access 1 and using the resource (e.g. boarding the ride) and to modify the estimated waiting time with this determined time.

The time may be determined by any suitable means. For example, visual recognition devices may be used to identify the individual user entering the primary access 101 and boarding the ride. These may look for visual clues such as facial recognition, distinctive clothing and so on. Other techniques may be used, such as having the individual user enter an identification code (such as a bar code or QR code) when entering the primary access and re-entering the identity code when boarding the ride. The time between the two entries is an accurate measurement of the time that the individual user has had to wait in the primary access 101. Other techniques include monitoring the user by, for example, RF tags, mobile device signals and so in.

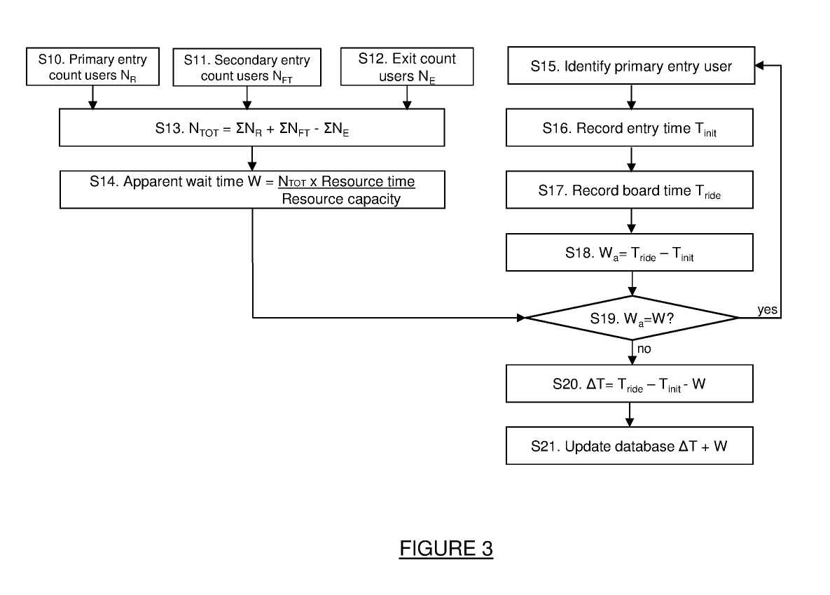

FIG. 3 illustrates the process, with the following numbering corresponding to that of FIG. 3:

S10. The number of users N_{R} entering the primary access 101 is counted using one or more people counters, and the largest of various numbers counted in a given time period is used. N_{R} is stored in a database.

S11. The number of users N_{FT} entering the secondary access 102 is counted using one or more people counters, and the largest of various numbers counted in a given time period is used. N_{FT} is stored in the database.

S12. The number of users N_{E} exiting the resource is counted using one or more people counters, and the largest of various numbers counted in a given time period is used. N_{E} is stored in a database.

S13. The total number of users waiting N_{TOT} can be found by N_{TOT}=ΣN_{R}ΣN_{FT}−ΣN_{E}

S14. The apparent wait time W is found by multiplying N_{TOT} by the time to use the resource (resource time being the time interval between consecutive people accessing the resource) and dividing by the resource capacity (in the case of a ride, this is the number of slots or seats). W is stored in the database. Steps S10 to S14 are a standard way to estimate waiting time.

S15. An individual user entering an entry point of the primary access 101 is selected and identified using one of the techniques described above (bar code, mobile device signals and so on).

S16. The entry time Tᵢₙᵢₜ of the individual user is noted.

S17. When the individual user is recorded as leaving an exit point of the primary access 101, the exit time T_{ride} is noted.

S18. The actual wait time Wₐ in the primary access for the individual user is determined by Wₐ=T_{ride}−Tᵢₙᵢₜ.

S19. A determination is made to see if the actual wait time Wₐ corresponds with the apparent wait time W. This need not be an exact match, but may be within an acceptable range. If so, then no further action need be taken and at a later period a further individual user is selected on entering the primary access 101.

S20. If Wₐ does not correspond to W, then W must be updated in the database. The time difference ΔT is determined by ΔT=T_{ride}−Tᵢₙᵢₜ−W.

S21. W is updated in the database by adding ΔT.

The techniques described above have been found in tests to greatly increase accuracy of the estimated wait time W.

If users book resource slots using the secondary access, then the number of secondary access bookings (and/or estimated bookings) during period W is added to N_{FT}. If no bookings are made then historical values of N_{FT} may be used to account for bookings using the secondary access.

Once an accurate value for W has been found, charging for using the secondary access 103 can be dynamically altered. At busy periods with long wait times, a user wishing to use the secondary access 103 may be charged more than would be charged at quiet periods.

In order to set a price for using the secondary access 103, the system may start with a base-price and details of the previous day's utilization of the resource and pricing of the resource. The database is also populated with the number of resource slots available, and the number of resource slots available to users wishing to user the secondary access 103. An estimate of use may be made using data such as car park utilization and park entry. It may be further modified by parameters such as the weather, the date, special events or promotion, unusual bulk sales and so on. These figures are used to estimate the demand level.

The system can then set a price for using the resource so as to maximise income by making the purchase price for secondary access 103 use higher at busy periods. The price for secondary access 103 may be dynamically altered throughout the day on the basis of wait times for the primary access 101. The prices may be stored in the database for subsequent use in predicting demand and prices.

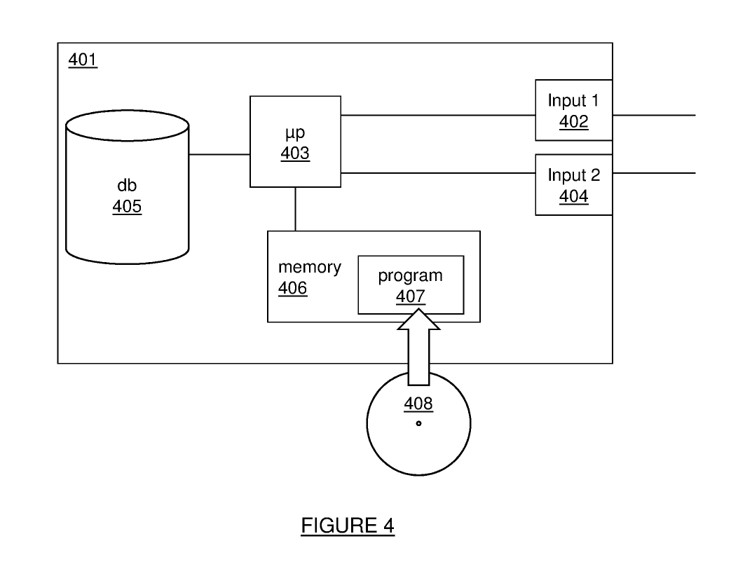

Turning now to FIG. 4, there is illustrated a computer device 401 for implementing the techniques described above. The computer device 401 is provided with a first data input 402 for receiving data relating to the number of users entering the primary access 101. A processor 403 is provided for determining W, as described above. A second data input 404 is provided for receiving Wₐ. The processor 403 can then calculate a wait time for the primary access 101 using both the W and Wₐ, and update the value for W in a database 405.

The processor 404 is also to dynamically determine a cost to access the resource via the secondary access 103 on the basis of the updated wait time for the primary access 101.

The computer device 401 may also be provided with a non-transitory computer readable medium in the form of a memory 406. This may be used to store a computer program 407 which, when executed by the processor 403, causes the computer to perform the steps shown in FIG. 3. Note that the computer program 407 may be provided on an external non-transitory computer readable medium such as a flash drive or disk 408.

Note that the resource described above typically uses a theme park ride as an example. However, the techniques for calculating wait times may be used with other resources, such as toll roads, taxi queues, art gallery entry, road works and so on.

It should be noted that FIGS. 2 and 3 merely provides an example of the steps that can be performed by the resource access management system in order to manage user access to a resource, and that the management of user access to a resource can comprise fewer steps, alternative steps, or additional steps in accordance with the methods described herein. In particular, it should be noted that not all of these steps are essential according to the methods described herein.

Each component of the resource access management system 100 described herein, including the primary access 101, secondary access 103, authorisation verifier 105, authorisation issuer 106, resource access manager 107, and primary access queue entrance 108 can be implemented by an appropriate combination of mechanical equipment and computer equipment configured to operate in accordance with the solutions described above. For example, at least the primary access 101, secondary access 103, and primary access queue entrance 108 can comprise both mechanical equipment such as a gate or turnstile together with computer equipment for implementing monitoring and control or people counting in accordance with the methods described above. By way of further example, the authorisation verifier 105, the authorisation issuer 106, and the resource access manager 107 can typically comprise computer equipment configured accordingly. Any computer equipment will comprise appropriately configured computer hardware and software, including but not limited to a processor, a memory, and a transceiver, and may further comprise an interface if required. For example, such an interface could comprise one or more of a graphic user interface, a user input device, a network interface, and a connector/interface for connecting peripherals. Of course, whilst it is preferable that the information/parameters used by the resource access management system 100 described herein are gathered automatically by the system components, it is to be appreciated that the information/parameters could equally be provided/input into the system manually in order to provide manual intervention and/or to provide for redundancy should any of the components be unavailable. If people counters are used, the primary and secondary accesses 101, 103 may be controlled by human operators.

Determining an accurate value for estimated wait time W allows a facility such as a theme park to base a charge for express entry on the amount of wait time saved. Theme park rides often have an entrance which is devoid of waiting in line through having a charge for this specific entrance. This entrance is often called the express entrance or the fast track entry.

A typical park visitor will only accept a charge that is proportional to the wait time saved if the park employs an accurate measuring system. A visitor can be informed of the estimated wait time through a digital display such as a public screen or an app provided to a visitor's smart phone.

Visitors who wish to move into the express line for getting onto the attraction without having to wait in the queue in the regular line can be charge a fee which is proportional to the calculated wait time of the regular queue. The fee will thus be seen by the guest as payment for not having to wait in the queue line for a given number of minutes. If a wait time is low, then the fee will be low, and if the wait time is high then the fee will be high.

Most theme park additional fees are currently based on fixed charges. At most theme parks, the fee allows the visitor to use the express entrances for the whole day. Consequently the fees are very large to reduce demand. Typically a maximum of 10% of the park's guests can be admitted to express entries. In many cases, it is very difficult to accurately predict which resources (such as rides) will be in demand.

Accurately estimating wait times and charging a visitor a fee proportional to the time save gives the advantages that it is available to all visitors on a ride by ride basis and is fair to all park guests.

Due the park's attractions having different wait times throughout the day, the fee for saved wait time will vary with time of day and from day to day due to the changes in queuing times, and whilst these are typically longer at busier times, they will also be longer on busier days.

The fee may be based on cost per minute saved, and could be the same for all rides or different for different rides. Obviously the wait time saved will vary from ride to ride. The more exciting attractions will probably have longer wait times and thus the cost of buying express entrance, (and thus not having to wait in the queue line), will vary with the park's visitors' demand for rides.

Park visitors can buy from the attraction operator an express entry ticket for this system in a number of ways e.g. from a park sales counter using a park POS ticket machines or through the visitor using their own personal IT system e.g., a smart phone. In this latter case an image of the ticket purchased appears on the screen or alternatively other identifying information can be displayed on the screen containing appropriate entry data/codes. Visitors can also use other personal communications systems in a similar way.

The system also allows visitors to buy “get-out-of-line minutes” in bulk at a price equal to the number of minutes multiplied by the price per minute. As the charge for a busy ride increases, demand will thus fall giving a stabilisation correction to the number of guests wanting to buy these tickets for this ride.

The issued “ticket” that allows the ride to be taken at a future point in time will be at exactly the same instant of time that a person, just then joining the regular line when the ticket is being bought, would gain normal access to the attraction. This ticket, which allows access to the attraction after the normal wait will be a basic ticket which would purely eliminate, for that user, the need to wait in line. The visitor would be free to wander the park and visit other attractions whilst spending this waiting time. After the wait, the person could go to the ride and enter the ride straight away.

In a further embodiment, the visitor can either buy the correct number of minutes for access to one ride so as to eliminate having to wait in line or the visitor can buy the minutes in bulk. Having booked the attraction they can then spend the out of line minutes as they wish, visiting other attractions in the park, having refreshments or simply relaxing.

If buying minutes in bulk, the number of minutes bought by a visitor will be held on the central IT system, through using a personal identifier code, and the central IT system would also hold the wait times of the rides. The central IT systems also store these wait times throughout the period when rides are operating. The visitor's personal data of unused minutes can also be shown on a printed ticket or can be shown on the personal communications device at the point of spending or when requested. In either case, when booking, the minutes used for each booking will be subtracted from the number of minutes associated with the visitor, and unallocated just before the booking is made, and the minutes remaining, i.e. the balance of the number of minutes on the guest's account printed or displayed.

Effectively the system creates an ‘account’ of minutes allowing the visitor to use the positive balance to purchase out of line queuing. This is effectively an accurate personal cyber queuing account.

Any minutes held at park closing could either be refunded at a pre-nominated price per minute, which will be shown when bulk purchase takes place, or could be held ready for the next visit to the park at a future date.

Paper tickets that have been issued by the park's POS and that have then been used to gain access to the attraction's fast entry line, can be collected from visitors on entry as a method of permanent cancellation. If a personal electronic device was used, the data can be deleted from this device electronically, as access to the ride is made.

Visitors who do not have a personal communications device or who do not want to use such an item can make bulk purchases of minutes and have those minutes held on the central system, in their account, ready for future use when purchasing at the POS stations. To allow visitors to watch their expenditure of their minutes, the balance can be printed out whenever a POS ticket is issued.

For visitors who want to reduce the wait time for going on the attraction to say half of the basic wait time, a quick entry ticket can be sold by using, for example, double the minute requirement of the basic wait time for the ride. This provides a “ticket” that effectively books a ride in half of the basic wait time. This time will be half the time that is being then displayed on the time waiting screens at the time of purchase. If demand for this quicker entry is too high for easy management of the system, this ratio of double the basic requirement can be made larger. Different ticket “times” can be charged at different rates.

Visitors who require immediate entry to the ride can satisfy this requirement by purchasing an instant entry ticket at a rate of, say, four times the rate required for a basic “ticket”. Much higher “charges” will be required for this type of ticket when compared to the basic ticket as only a limited number can be issued during the day without grossly altering the normal operation of the ride. Pricing mechanisms will need to be precise to control appetite and demand.

The pricing ratios described above are for example purposes only, and park operations management will have to monitor customer demand so that sensible and correct ratios can be used. Also other variants of ratios and percentage wait time can be used to satisfy customer demand.

The price of a “minute-out-of-line” can be the same throughout the day and throughout the weeks, and also the same for all rides. Therefore, when a quiet day is expected with low customer attendance, and thus queue lines will be shorter than normal experience on a busy day, a limited number of minutes per visitor could be offered at slightly reduced prices. Care will have to taken with this discount size as the tickets are a currency and will have a potentially higher value on future busy days. Effectively the park will have a currency exchange for money and “out of line” minutes.

It will be understood by visitors and operators that on busy days the requirement to escape waiting in line will need larger quantities of purchased “out of line” minutes than would have been required on a less busy day. This demonstrates a major aspect of the system. For a fixed price per minute, use will be governed by the length of the waiting time. Unlike any existing system, the fixed price nature of the system has a built in price/demand control and thus automatically responds to visitor demand. This response is not set by the operator who had initially set the money-minutes exchange rate as the price per minute is effectively set purely by long term demand.

Out of line minutes can be used as a customer incentive with product sales at any participating stall or trading platform. For example, demand for hamburgers might increase if a number of out of line minutes were given with each purchase.

Visitors could be further encouraged into specific trading through a parallel golden Q-line token. E.g. one for each hour of out-of-q-line minutes spent. This customer loyalty programme could then give reduced prices when purchasing next year's season ticket.

Out of line tickets can be used to control demand to specific areas of the attraction, e.g. the highly prized front seats of a ride, back seats on a ride, front row of seats in a static attraction such as an aquatic display, by requiring the guest to pay more minutes from his “out of line” minutes account, to obtain these very desirable seats.

Note that the concept of charging proportionally to waiting time saved can be applied regardless of how the waiting time saved is calculated.

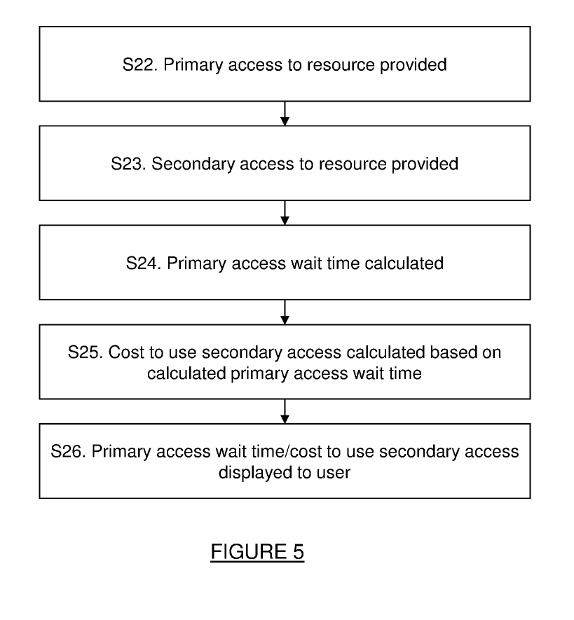

FIG. 5 is a flow diagram showing exemplary steps. The following numbering corresponds to that of FIG. 5:

S22. A primary access having a first entry point and a first exit point is provided to allow a user to access the resource.

S23. A secondary access is also provided to allow a user to access the resource.

S24. A computer device calculates a wait time to access the resource using the primary access

S25. A charging module determines, on the basis of the calculated wait time, a price to access the resource using the secondary access. The price to access the resource using the secondary access may be directly proportional to the calculated wait time.

S26. The calculated wait time that could be saved by using the secondary access is provided to the user, either by using a public display or by displaying the information on the user's mobile device.

A similar system to that described above for use in theme parks can be used in traffic control systems.

Normally, demand for road usage can currently be repressed through a toll charge, which typically is fixed. Some road toll systems use daily or day-time variations, e.g. smaller charges at the weekend or through the night. However, these fixed amounts cannot suddenly respond to unexpected increased demand and the system can be easily overloaded. Other mechanisms are being used such as nominating lanes that can only be used by cars that have at least two or more occupants; a not unusual approach to congested freeway traffic problems in the USA. However, these lanes frequently operate at a relative low capacity and thus annoy users of the slowly moving regular lane.

Many roads suffer from regular congestion with the road blockage at times that are often repeated with some degree of consistent repetition: morning rush hour, evening home going, before the start of a key sporting event, etc. Simply enforcing a toll or other blanket restriction is a blunt instrument that cannot respond to these variations.

An alternative method of control is through the use of a payment mechanism which levies a charge that is proportional to the delay caused by the congestion to the normal traveller. Having paid this charge, the routing can be specified so that the delay is eliminated. This can be done by the use of a special lane, e.g. the special two car occupants lane.

Typically a tail back of traffic caused by some restriction such as a road junction is often of a known length and, when travelling, can be determined when the traffic speed changes.

By measuring wait times as described above, a road user can be charged for a toll road proportionally to an amount of time saved had the road user taken another route. The system has a series of electro-optic sensors above the traffic lanes at appropriate intervals, which measure traffic flow well before an expected start of the slowly moving traffic. Sensors measure the volume, speed, and identity of the passing stream of vehicles and this data is fed to a central IT system which has records of previous flows and collects the current sensor's output. Other sensors are arranged through the area that is likely to be congested and send movement data to the central system. A sensor at the point of restriction that is causing the bottle neck then sends the last batch of data for each vehicle so that the time of transit can be measured. Licence plate or vehicle colour and shape can be used to identify each car or truck and through following its progress measure its speed and expected progress.

Using this data, a comparison is made against a previous free flowing environment and when the then current delay is above a chosen value, e.g. five minutes, in which case the approaching traffic at the start of the constrained area is offered one lane of the road as a chargeable route and all drivers that want to save delayed time can opt for that direction.

The charge for the constriction free route is assessed at a fixed rate per minute saved and the driver will pay this amount or have this amount deducted from a pre-purchased account.

The then current delay is shown on a screen to the oncoming drivers and if the system predicts a worsening on the travel time this is shown to the drivers on a second screen.

Collecting payment form the drivers can be dealt with in a number of different ways.

Roads can be designed and organised on this basis so that if, for example, an accident suddenly causes a constriction, people who are grossly affected by the ensuing delay could purchase the ability to use a cleared lane, whilst other motorists have to wait in their lane. The central computer in this particular case can organise charging from previous experience, knowledge, customer behaviour and other background details. Thus with this system in place those people who might be about to miss an aeroplane could avail themselves of an alternative to frustratingly sitting in the stationary queue.

Regular drivers can buy an account, kept electronically, of prepaid minutes. The system sensors having recorded the vehicle's identity can deduct the payment from the vehicle's account, in a similar manner to current IT enabled toll-road charging.

Other drivers can opt to go to a toll gate at the end of the constriction and tender payment.

Although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. For example, whilst some of the above embodiments have described the resource access management system 100 with respect to controlling access to a single resource, the resource access management system 100 could equally be configured with a single resource access manager 107 in communication with and controlling access to a number of different resources, each with their own primary access and one or more secondary access(es). The resource access management system 100 could thereby coordinate the implementation of the access management for all of these resources. Alternatively, the resource access management system 100 for a number of different resources could comprise a plurality of resource access managers 107. In this regard, each of the plurality of resource access managers 107 could be in communication with each other, so as to collectively form a distributed resource access management system, or could also be in communication with a centralised supervising resource access manager that would be configured to coordinate the implementation of the booking system by each of the individual resource access managers.

1. A resource access management system to manage user access to a resource having a number of resource slots, wherein each resource slot can be used by a user, the resource access management system comprising:
a primary access through which a user accesses the resource, the primary access having a first entry point and a first exit point;
a secondary access through which to allow the or a further users accesses the resource;
a user identifier which identifies each user;
and a computer device having a first data input which receives data relating to a number of users entering the primary access corresponding to the user identifier, a processor which determines an apparent wait time based on the number of users entering the primary access and the secondary access corresponding to the user identifier, and a predetermined resource time associated with the resource, and a second data input relating to a periodically determined actual wait time of a selected user between entering the first entry point and exiting first exit point;
wherein the processor calculates a wait time of the primary access using both the apparent wait time and the actual wait time.

2. The resource access management system according to claim 1, wherein the second data input receives data of the actual wait time between a user entering and exiting based on a wireless signal from a user-identifier device associated with the user.

3. The resource access management system according to claim 2, wherein the user-identifier device comprises any of a mobile terminal, a radio frequency tag, a card comprising an identification code and a uniquely identifiable user identity feature.

4. The resource access management system according to claim 1, wherein a visual recognition device is located at the first entry point and the first exit point, outputting the actual wait time to the second data input.

5. The resource access management system according to claim 1, further comprising the processor dynamically determining a cost to access the resource via one of: the secondary accesses on the basis of the calculated wait time for the primary access; and the secondary access on the basis of a combination of the calculated wait time for the primary access and any of historical wait times, marketing promotions, date, system overheads, speed of access, and weather.

6. (canceled)

7. The resource access management system according to claim 1, wherein the resource comprises a seat on a ride.

8. The resource access management system according to claim 1, wherein the primary access is a route on a road and the secondary access is an alternative route on the road.

9. The resource access management system according to claim 1, further comprising a further secondary access to allow users to access an alternative resource.

10. The resource access management system according to claim 1, further comprising the processor calculating the wait time on the further basis of known or estimated bookings for resources using the secondary access.

11. The resource access management system according to claim 1, which manages access to a plurality of resources.

12. The resource access management system according to claim 1, further comprising a charging module arranged to determine a secondary-access charge for the secondary access to the resource based on the calculated wait time.

13. The resource access management system according to claim 12 wherein the secondary-access charge for the secondary access to the resource is directly proportional or correlated to the calculated wait time.

14. The resource access management system according to claim 12, the system further comprising a wait-time indictor which informs the user of the calculated wait time for the resource, the wait-time indictor selected from any of a display screen in a public area and a mobile-device transmitter which send to a user mobile device information including the identity of the resource and the calculated wait time.

15. The resource access management system according to claim 12, wherein the charging module includes a data storage device which stores data relating to the user, the data including an identity of the user and an account of money and/or early entry waiting time available to the user.

16.-19. (canceled)

20. The resource access management system according to claim 1, further comprising an electronic-memory which stores, for each user, an identity of the user and an account of money and/or early entry waiting time available to the user.

21.-26 (canceled)

27. A method of calculating a wait time for a user to access a resource, the method comprising, using a computer:
determining an apparent wait time based on a number of users entering a first entry point of a primary access and a number of users booked to enter or entering a secondary access, and a predetermined resource time associated with the resource;
periodically determining an actual wait time of a selected user between entering the first entry point and exiting a first exit point of the primary access; and calculating a wait time for the primary access using both the apparent wait time and the actual wait time.

28. The method according to claim 27, further comprising dynamically determining a cost to access the resource via the secondary access on the basis of the calculated wait time for the primary access.

29. The method according to claim 27, further comprising dynamically determining a cost to access the resource via the secondary access on the basis of a combination of the calculated wait time for the primary access and any of historical wait times, marketing promotions, date, system overheads, speed of access, and weather.

30. The method according to claim 27, further comprising calculating the wait time on the further basis of known or estimated bookings for resources using the secondary access.

31. A resource access management system to manage user access to a resource having a number of resource slots, wherein each resource slot can be used by an identifiable user, the resource access management system comprising:
a primary access through which a user accesses the resource, the primary access having a first entry point and a first exit point;
a secondary access through which users access the resource;
a user identifier which identifies each user;
an apparent-wait-time-determination processor which determines an apparent wait time based on a number of users identified by the user identifier entering the primary access and the secondary access, and a predetermined resource time associated with the resource;
an actual-wait-time-determination processor which, based on the user identifier, periodically determines an actual wait time of a selected user between entering the first entry point and exiting first exit point; and
a wait-time calculator which calculates a wait time for the primary access using both the apparent wait time and the actual wait time.
